(19) United States
(12) Patent Application Publication
(10) Pub. No.: US 2026/0295568 A1
(43) Pub. Date: Oct. 1, 2026

(54) PREPARATION OF MESO-Y-ZEOLITE WITH LARGE MESOPORES

(71) Applicants: The Regents of The University of California, Oakland, CA (US); Chevron U.S.A. Inc., San Ramon, CA (US)

(72) Inventors: Alexander KATZ, Richmond, CA (US); Xuemin LI, Berkeley, CA (US); Bi-Zeng ZHAN, Albany, CA (US); Cong-Yan CHEN, Kensington, CA (US); Jinyi HAN, San Ramon, CA (US)

(73) Assignees: The Regents of The University of California, Oakland, CA (US); Chevron U.S.A. Inc., San Ramon, CA (US)

(21) Appl. No.: 19/573,162

(22) Filed: Mar. 20, 2026

Related U.S. Application Data
(60) Provisional application No. 63/778,992, filed on Mar. 27, 2025.

(51) Int. Cl. B01J 29/08; B01J 23/06; B01J 35/61; B01J 35/63; B01J 35/64; B01J 37/03; B01J 37/06; B01J 37/10; C01B 39/02; C01B 39/24

(52) U.S. Cl. CPC B01J 29/088; B01J 23/06; B01J 35/615; B01J 35/617; B01J 35/635; B01J 35/647; B01J 37/031; B01J 37/06; B01J 37/10; C01B 39/026; C01B 39/24; B01J 2229/186; B01J 2229/37; C01P 2002/72; C01P 2006/14; C01P 2006/16

(57) ABSTRACT

Provided is a large mesopore Y zeolite comprising mesopores of at least 18 nm in diameter and a micropore volume of at least 0.16 cm³/g. A process of preparing the large mesopore Y zeolite is also provided. The process allows the synthesis of a zeolite material with large mesopores while also avoiding the common trade of a substantial loss of crystallinity.

### CROSS REFERENCE TO RELATED APPLICATION

The present application claims priority to U.S. Provisional Patent Application No. 63/778,992, filed on Mar. 27, 2025, the complete disclosure of which is incorporated herein by reference in its entirety.

### TECHNICAL FIELD

The present disclosure generally relates to mesoporous zeolites and methods of making mesoporous zeolites. Specifically, the present disclosure relates to large mesopore USY zeolites retaining a high degree of crystallinity and methods of making the same.

### BACKGROUND

An ongoing goal in the field of solid acid catalysis with zeolites is to increase the mesopore size of the solid-acid zeolite catalyst in the range of 20 nm and larger, while retaining zeolite crystallinity. Those skilled in the art know that there is typically a tradeoff between synthesis of large mesopore diameters and zeolite crystallinity. This tradeoff occurs because the synthesis of the large mesopore diameters in appreciable mesopore volume typically involves partial dissolution of the zeolite framework, leading to a loss of crystallinity. It would be of great value to the industry if there was a synthesis of a material that goes against this common tradeoff. A synthesis that would provide a material that has both higher crystallinity as well as larger mesopore diameters spanning 18 nm and higher.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure encompasses a variety of aspects that may not be set forth below.

Provided is a zeolite material that has both high crystallinity and larger mesopore diameters. The zeolite material has a micropore volume of at least 0.16 cm³/g and mesopore diameters of at least 18 nm.

Micropore volume is indicative of the degree of zeolite crystallinity retention within a mesoporous Y material, with larger micropore volumes corresponding to greater amounts of crystallinity. A micropore volume of 0.16 cm³/g is indicative of a high crystallinity. The zeolite material also exhibits mesopore diameters of 18 nm and higher. In one embodiment, the material is a large mesopore USY zeolite retaining a high degree of crystallinity.

The zeolite material is prepared by heating in an aqueous basic solution a surfactant, a meso-Y-zeolite and a zinc salt, preferably zinc nitrate. After recovering, washing and drying the precipitated solids, the solids are calcined. The calcined material is then subjected to a hydrothermal treatment, after which the hydrothermally treated material is calcined. In one embodiment, the hydrothermal and calcined material is subjected to an acid wash. The resulting zeolite material is unique in that both zeolite crystallinity is preserved while large 18 nm mesopores or larger are synthesized.

Among other factors, the present synthesis has been found to synthesize a zeolite material with large mesopores, while also avoiding the common trade of a loss of crystallinity. The synthesized material has mesopores of at least 18 nm in diameter, and also a micropore volume of at least 0.16 cm³/g.

### BRIEF DESCRIPTION OF THE DRAWINGS

FIG. 1A depicts nitrogen physisorption/desorption isotherms at 77 K.

FIG. 1B graphically depicts density functional theory (DFT) pore size distributions.

FIG. 2 depicts powder X-ray diffraction (PXRD) patterns of materials after hydrothermal treatment and calcination.

FIG. 3A depicts nitrogen physisorption/desorption isotherms at 77 K.

FIG. 3B graphically depicts DFT pore size distributions.

FIG. 4 depicts PXRD patterns of materials after acid wash and calcination.

### DETAILED DESCRIPTION

Before the mesoporous Y zeolites and the processes for preparing them are disclosed and described, it is to be understood that this disclosure is not limited to the particular structures, process steps, or materials disclosed herein, but is extended to equivalents thereof as would be recognized by those ordinarily skilled in the relevant arts. It should also be understood that terminology employed herein is used for the purpose of describing particular embodiments only and is not intended to be limiting. It must be noted that, as used in this specification, the singular forms “a,” “an,” and “the” include plural referents unless the context clearly dictates otherwise. Thus, for example, reference to “a step” may include multiple steps, reference to “producing” or “products” of a reaction or treatment should not be taken to be all of the products of a reaction/treatment, and reference to “treating” may include reference to one or more of such treatment steps. As such, the step of treating can include multiple or repeated treatment of similar materials/streams to produce identified treatment products.

Numerical values with “about” include typical experimental variances. As used herein, the term “about” means within a statistically meaningful range of a value, such as a stated particle size, concentration range, time frame, molecular weight, temperature, or pH. Such a range can be within an order of magnitude, typically within 10%, and more typically within 5% of the indicated value or range. Sometimes, such a range can be within the experimental error typical of standard methods used for the measurement and/or determination of a given value or range. The allowable variation encompassed by the term “about” will depend upon the particular system under study, and can be readily appreciated by one of ordinary skill in the art. Whenever a range is recited within this application, every whole number integer within the range is also contemplated as an embodiment of the invention.

The present process relates to a large mesoporous material synthesis, and particularly in one embodiment a mesoporous Y material, which combines the surfactant-templating approach and the addition of a Zn salt species. In general, the process comprises providing a parent Y-zeolite, which zeolite can be a conventional meso-Y-zeolite. In one embodiment, the Y-zeolite has been or is treated with a surfactant, as is known. The surfactant can be any suitable surfactant, but is preferably a cetyltrimethylammonium (CTA) surfactant. In one embodiment, the CTA is a bromide (CTAB) surfactant. The meso-Y-zeolite is also treated with a zinc salt species. The zinc salt can be an acid salt such as zinc nitrate. Zinc nitrate is the preferred zinc salt for use in the synthesis. The amount of zinc species combined together with the Y-zeolite can be any suitable amount. In one embodiment, the amount of zinc salt species can range from about 20 to 40 wt. % based on the weight of the zeolite. In one embodiment, the amount is about 30 wt. % zinc species. The treatment generally occurs in a basic solution, such as an aqueous NaOH solution. In one embodiment, the surfactant and zinc salt are heated together with the parent Y zeolite in the basic solution.

After treatment of the Y zeolite with the surfactant and the zinc salt, the solution is generally filtered to collect the solids. The precipitated solids are then washed carefully until the filtrate exhibits a neutral pH. After drying, the washed solids are calcined. The washing also removes any residual zinc species.

The calcination is conducted under conventional calcination conditions. The temperature can range from about 500° C. to 600° C. in one embodiment and can be about 580° C. in one embodiment. The calcination is generally conducted in dry air. In one embodiment the calcination is conducted in dry air at about 580° C. The length of time can generally range from about 3-7 hours, and in one embodiment is about 5 hours. The length of time is somewhat dependent on the temperature of the calcination.

Subsequent to the calcination, the washed and calcined material is subjected to a hydrothermal treatment. The hydrothermal treatment is essentially an aqueous wash with heat. The aqueous solution in one embodiment can comprise deionized water. The washed and calcined material, in one embodiment can be added to an aqueous solution such as a deionized water solution and the resulting solution added to an autoclave. The hydrothermal treatment is generally run at a temperature of about 130° C. to 190° C. In one embodiment, the temperature of the hydrothermal treatment can range from about 135° C. to 175° C., and in one preferred embodiment at around 135° C. The length of the treatment is generally about 15 to about 18 hours, for example, about 16 hours in one embodiment. The hydrothermally treated material can then be washed with an aqueous solution, e.g., of deionized water, dried and then calcined following the calcination procedure noted above.

The large mesopores have been found that they can be even more enhanced by a final acid wash of the recovered large mesopore meso-Y zeolites. The acid wash is essentially an aqueous acid wash with heat. The aqueous acid solution used can have a varied acid concentration, as is suitable. Generally, the acid concentration in the solution used ranges from about 0.05 M to about 0.30 M. In one embodiment, the acid concentration can range from about 0.10 M to about 0.30 M, or is about 0.10 M in another embodiment. The treatment is run at a temperature of about 100° C. to 190° C. In one embodiment, the temperature of the hydrothermal treatment can be about 100° C. The length of the treatment is generally above 15 to about 18 hours, for example, about 16 hours in one embodiment. The acid washed material is then washed, dried and calcined as described above. The acid wash can be with an aqueous nitric acid or hydrochloric acid solution, or any suitable acid solution. An aqueous nitric acid solution is preferred. It has been found that the acid wash may remove some oxide debris and thus even further enlarge at least the volume of the large mesopores.

The present examples are produced to further illustrate the present zeolites and methods of preparation. The examples are illustrative and are not meant to be limiting.

### EXAMPLES

### Material Characterization

N₂ physisorption isotherms and powder X-ray diffraction (PXRD) patterns were measured using conventional procedures and devices. In detail, N₂ physisorption isotherms were measured at 77 K on a Micromeritics ASAP2020 adsorption instrument. The material was degassed at 350° C. for 4 h under vacuum before analysis. The micropore volume, micropore surface area, and external surface area were measured by the t-plot method. DFT pore-size distributions were calculated from the adsorption branch, and the mesopore volume was calculated from the adsorption branch using the Barrett-Joyner-Halenda (BJH) method. Powder X-Ray diffraction (PXRD) patterns were collected on a Rigaku Mini Flex diffractometer using a Cu Ka radiation (40 kV, 15 mA) ranging from 5 to 50° with a step size of 0.01°.

### Example 1

### Synthesis of Material 1

120 g of 0.16 M aqueous NaOH solution and 3.0 g hexadecyltrimethylammonium bromide (C₁₆TAB) were added to a plastic round-bottom flask (250 mL) and heated with a 90° C. oil bath under rapid stirring (approximately 700 RPM with a magnetic stir bar) for 25 min. Subsequently, 6.0 g Ultrastable Y (USY) zeolite with a SiO₂/Al₂O₃ molar ratio of 30 (available from Zeolyst as CBV720) was added to the solution, followed immediately by 2.19 g Zn(NO₃)2·6H₂O (corresponding to 0.6 g ZnO; 10 wt. % of the zeolite amount). The whole solution was then stirred (approximately 700 RPM with a magnetic stir bar) while heating with a 90° C. oil bath for 6 h. After cooling, the contents were poured into a filter, and the precipitated solids were washed several times with deionized water until neutral pH of the filtrate was achieved. The sample was finally dried at 60° C. overnight before being calcined in dry air at 580° C. for 5 h (ramp rate 2° C./min). The calcined material after synthesis is hereafter referred to as 1-C.

### Example 2 (Comparative)

### Synthesis of Comparative Material 2

The same procedures as described in Example 1 were used for the synthesis of comparative material 2, except 0.6 g of ZnO nanoparticles (MZ-500 uncoated zinc oxide from Tayca Corporation, 25 nm primary particle size, the surface area of 45 m²/g) was added instead of 2.19 g Zn(NO₃)₂·6H₂O, at the same juncture in the synthesis. All other procedures were the same. The calcined material after synthesis is hereafter referred to as 2-C.

### Example 3 (Comparative)

### Synthesis of Comparative Material 3

Comparative material 3 consists of conventional Meso-Y, which was synthesized according to the same procedures as described above for comparative material 2, except that no zinc oxide was added. The calcined material after synthesis is hereafter referred to as 3-C. Material 3-C was converted to a proton form via ion-exchange with 1 M NH₄NO₃ aqueous solution (aqueous solution to zeolite weight ratio of 50:1) at 60° C. for 24 h, followed by washing several times with deionized water until neutral pH of the filtrate was achieved. The sample was finally dried at 60° C. overnight. This entire ion-exchange procedure was repeated another two times before calcining the material in dry air at 580° C. for 5 h (ramp rate 2° C./min). The ion-exchanged and calcined material derived from 3-C is hereafter referred to as 3-C—H.

### Example 4

### Hydrothermal Treatment of Calcined Materials

Hydrothermal treatment (HT) was performed by taking 0.5 g of the calcined (580° C. for 5 h) material (i.e., 1-C and 2-C) and adding it to 17.5 g of deionized water solution in a 20 mL autoclave. The mixture was heated at a temperature of 135° C. for 16 h in a rotary oven (~20 RPM). The hydrothermally treated material was washed with deionized water, dried, and calcined following the same procedures as described above. The hydrothermally treated materials derived from 1-C and 2-C are hereafter referred to as 1-C-HT and 2-C-HT, respectively.

### Example 5

### Final Acid Wash

0.5 g of hydrothermally treated and calcined material was added to 17.5 g of 0.10 M aqueous HNO₃ solution in a 20 mL autoclave. The mixture was heated at 100° C. for 16 h in a rotary oven (~20 rpm). Washing, drying, and calcination procedures were the same as described above. The acid-washed and calcined materials derived from 1-C-HT and 2-C-HT are hereafter referred to as 1-C-HT-AW and 2-C-HT-AW, respectively.

### Example 6

### Characterization of Materials Via N₂ Physisorption at 77 K and PXRD

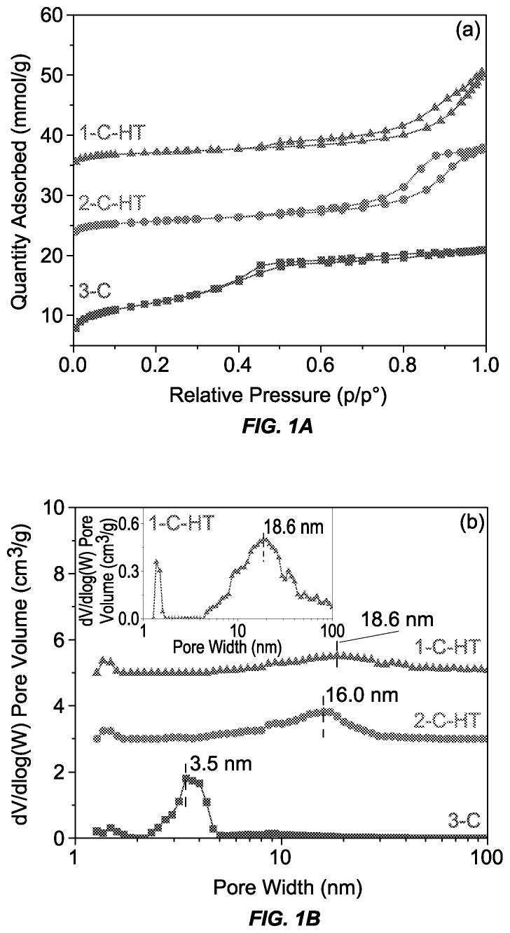

Data in FIG. 1A shows the N₂ physisorption isotherms at 77 K for calcined materials 1-C-HT, 2-C-HT and 3-C. The DFT pore-size distribution (PSD) of these isotherm data shown in FIG. 1B demonstrates the expected 3.5 nm mesopore diameter in 3-C, which is the expected mesopore size for conventional mesoporous Y zeolite (see X. Li et al., Micropor. Mesopor. Mater. 2024, 373, 113100). The PSD data in FIG. 1B demonstrate a much larger 16 nm mesopore diameter for 2-C-HT, with similar mesopore volumes for 2-C-HT and 3-C in Table 1 below. The same mesopore volume for 3-C-HT is observed in Table 1, with a PSD in FIG. 1B that is now much broader and shifted to a larger mesopore diameter of 18 nm compared with 3-C and 2-C-HT.

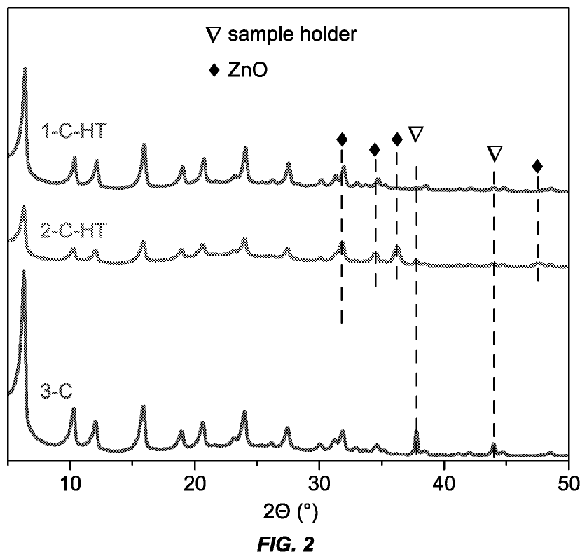

The micropore volume is known to directly reflect the degree of zeolite crystallinity retention within a mesoporous Y material, with larger micropore volumes corresponding with greater amounts of crystallinity. Data in Table 1 below show a similar micropore volume for the conventional mesoporous Y material 3-C and 1-C-HT, in the range of 0.15-0.16 cm³/g, suggesting only slightly more zeolite crystallinity in the latter compared to the former. This is to be contrasted with the much lower micropore volume of 2-C-HT of 0.10 cm³/g, which is indicative of a lower degree of zeolite crystallinity in this material. The trends in the micropore volume described above (namely the greater degree of expected crystallinity in the order 2-C-HT<3-C approximately equal to 1-C-HT) are reflected in the PXRD (powder X-ray diffraction) data of FIG. 2. In particular, approximately the same intensity for 3-C and 1-C-HT is observed, and significantly lower intensity for 2-C-HT. These trends in crystallinity above translate directly to greater amounts of tetrahedral framework Al (the coordination environment of Al that should yield Brønsted acidity in the proton forms of the zeolites). In conclusion, when interpreting the micropore volumes in Table 1, the synthesis of material 1-C-HT is unique in that both zeolite crystallinity is preserved while large 18 nm mesopores are synthesized. This unique combination of traits cannot be accomplished in either material 3-C or 2-C-HT.

TABLE 1
Textural properties of materials after HT and calcination

| | DFT pore | Surface area (m²/g) | | | Volume (cm³/g) | | |
|---|---|---|---|---|---|---|---|
| Sample | size (nm) | S_{BET}^{a} | S_{micro}^{b} | Sₑₓₜₑᵣₙₐₗ^{c} | Vₜₒₜₐₗ | V_{micro}^{d} | Vₘₑₛₒ^{e} |
| 1-C-HT | 18.6 | 599 | 403 | 196 | 0.72 | 0.16 | 0.56 |
| 2-C-HT | 16.0 | 470 | 251 | 218 | 0.66 | 0.10 | 0.56 |
| 3-C | 4.0 | 918 | 353 | 565 | 0.72 | 0.15 | 0.57 |

ªS_{BET} = BET surface area (total surface area);
^{b}S_{micro} = micropore surface area, t-plot method;
^{c}Sₑₓₜₑᵣₙₐₗ = external surface area, t-plot method;
^{d}V_{micro} = micropore volume, t-plot;
^{e}Vₘₑₛₒ = mesopore volume, BJH method from adsorption.

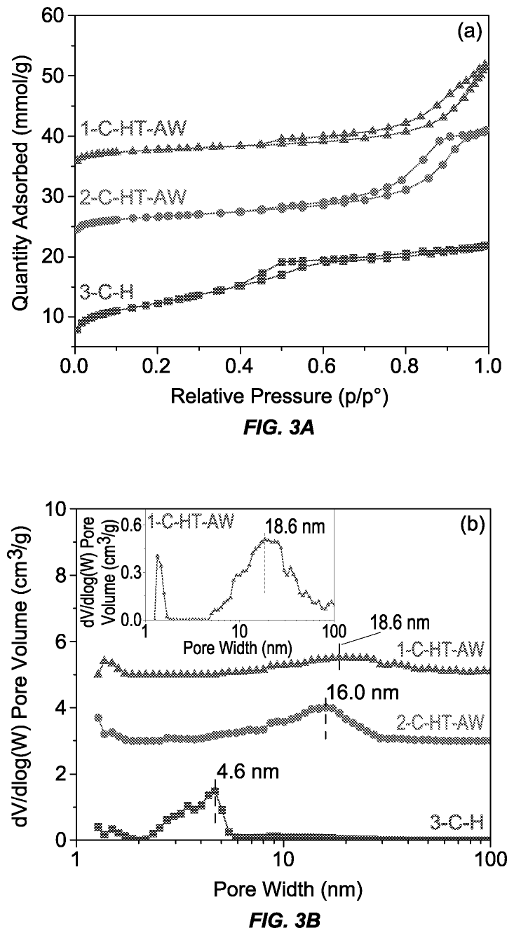

Data in FIG. 3A shows N₂ physisorption isotherms at 77 K for calcined materials 1-C-HT-AW, 2-C-HT-AW, compared with 3-C. For the two zinc-containing materials similar PSD data is observed in FIG. 3B as compared with the same materials before final acid wash in FIG. 1B, with greater mesopore volume for the materials after versus before acid wash. It is concluded that some oxide debris was removed during the final acid wash, leading to the observed increased mesopore volumes for 1-C-HT-AW compared with 1-C-HT (and similarly 2-C-HT-AW compared with 2-C-HT). Data in Table 2 demonstrates that ion-exchanged material 3-C—H has a slightly enlarged mesopore diameter and mesopore volume, and slightly diminished micropore volume, relative to its predecessor before ion exchange, 3-C. On an absolute scale, all three materials (1-C-HT-AW, 2-C-HT-AW, and 3-C—H) exhibit similar mesopore volumes in the range of 0.60-0.65 cm³/g.

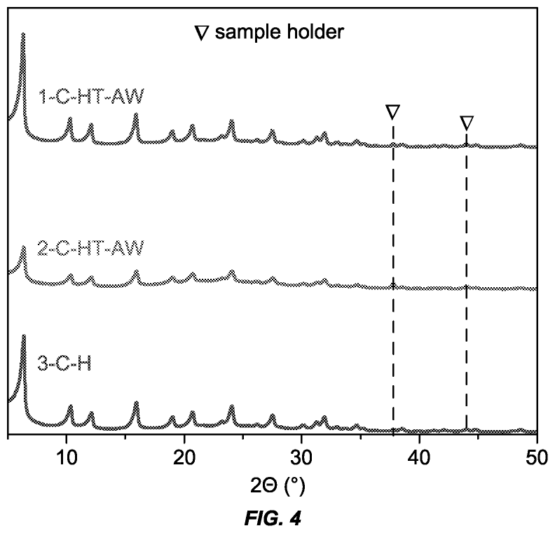

Of the three materials in Table 2, 1-C-HT-AW shows the highest micropore volume of 0.17 cm³/g. This material is to be contrasted with the much lower micropore volume of 2-C-HT-AW of 0.11 cm³/g, indicative of a lower degree of zeolite crystallinity in this latter material. In conclusion, when interpreting the micropore volumes in Table 2, it is surmised that the synthesis of material 1-C-HT-AW is unique in that both the highest degree of zeolite crystallinity is preserved, while the largest 18 nm mesopores are synthesized. A closer view of the inset of FIG. 3B shows the PSD of 2-C-HT-AW to span a broad diameter range from 6.0 nm up to 73.5 nm, with a maximum at 18.6 nm diameter. The trends in the micropore volume described above (namely the greater degree of expected crystallinity in the order 2-C-HT-AW<3-C—H<1-C-HT-AW) are reflected in the PXRD data of FIG. 4. In particular, the greatest intensity is observed for 1-C-HT-AW, lower intensity for 3-C—H, and the lowest intensity for 2-C-HT-AW. These trends in crystallinity above translate directly to greater amounts of tetrahedral framework Al and therefore Brønsted acidity for 1-C-HT-AW when comparing all three materials (1-C-HT-AW, 2-C-HT-AW, and 3-C—H) in their proton forms above. This unique combination of traits (higher crystallinity and larger mesopore size) cannot be accomplished in either material 3-C—H or 2-C-HT-AW.

TABLE 2
Textural properties of materials after HT and calcination

| | DFT pore | Surface area (m²/g) | | | Volume (cm³/g) | | |
|---|---|---|---|---|---|---|---|
| Sample | size (nm) | S_{BET}^{a} | S_{micro}^{b} | Sₑₓₜₑᵣₙₐₗ^{c} | Vₜₒₜₐₗ | V_{micro}^{d} | Vₘₑₛₒ^{e} |
| 1-C-HT-AW | 18.6 | 648 | 422 | 227 | 0.77 | 0.17 | 0.60 |
| 2-C-HT-AW | 16.0 | 546 | 270 | 276 | 0.76 | 0.11 | 0.65 |
| 3-C-H | 4.6 | 983 | 324 | 713 | 0.77 | 0.14 | 0.63 |

ªS_{BET} = BET surface area (total surface area);
^{b}S_{micro} = micropore surface area, t-plot method;
^{c}Sₑₓₜₑᵣₙₐₗ = external surface area, t-plot method;
^{d}V_{micro} = micropore volume, t-plot;
^{e}Vₘₑₛₒ = mesopore volume, BJH method from adsorption.

As used in this disclosure the word “comprises” or “comprising” is intended as an open-ended transition meaning the inclusion of the named elements, but not necessarily excluding other unnamed elements. The phrase “consists essentially of” or “consisting essentially of” is intended to mean the exclusion of other elements of any essential significance to the composition. The phrase “consisting of” or “consists of” is intended as a transition meaning the exclusion of all but the recited elements with the exception of only minor traces of impurities.

All patents and publications referenced herein are hereby incorporated by reference to the extent not inconsistent herewith. It will be understood that certain of the above-described structures, functions, and operations of the above-described embodiments are not necessary to practice the present invention and are included in the description simply for completeness of an exemplary embodiment or embodiments. In addition, it will be understood that specific structures, functions, and operations set forth in the above-described referenced patents and publications can be practiced in conjunction with the present process and system, but they are not essential to its practice. It is therefore to be understood that the invention may be practiced otherwise than as specifically described without actually departing from the spirit and scope of the present invention as defined by the appended claims.

While various embodiments have been described for purposes of this disclosure, various change and modifications may be made which are well within the scope contemplated by the present disclosure. Numerous other changes may be made which will readily suggest themselves to those skilled in the art and which are encompassed in the spirit of the disclosure.

What is claimed is:

1. A process for preparing a large mesopore Y zeolite comprising:
a) providing a parent Y zeolite and heating the Y zeolite in a basic solution with a zinc salt;
b) collecting solids from a) and washing and drying the solids;
c) calcining the washed solids from b);
d) subjecting calcined solids from c) to a hydrothermal treatment, and
e) calcining hydrothermal treated material from d).

2. The process of claim 1, wherein the parent Y zeolite has been treated with a surfactant.

3. The process of claim 1, wherein a surfactant is included in the basic solution of a).

4. The process of claim 3, wherein the surfactant is a cetyltrimethylammonium (CTA) surfactant.

5. The process of claim 4, wherein the CTA surfactant comprises cetyltrimethylammonium bromide (CTAB).

6. The process of claim 1, wherein the zinc salt comprises zinc nitrate.

7. The process of claim 1, further comprising an acid wash of calcined hydrothermal treated material from step e).

8. The process of claim 7, wherein the acid wash comprises heating the material in an aqueous acid solution.

9. The process of claim 8, wherein the aqueous acid solution comprises nitric acid at a 0.10 M concentration.

10. The process of claim 9, wherein the acid wash heating is conducted at a temperature of about 100° C.

11. The process of claim 1, wherein the hydrothermal treatment is conducted at a temperature of about 130° C. to about 190° C.

12. The process of claim 11, wherein the temperature is about 135° C.

13. The process of claim 11, wherein the length of the treatment is about 15 to about 18 hours.

14. The process of claim 1, wherein a large mesopore Y zeolite is recovered after step e) which has mesopores of at least 18 nm in diameter and a micropore volume of at least 0.16 cm³/g.

15. The process of claim 7, wherein a large mesopore Y zeolite is recovered after the acid wash which has mesopores of at least 18 nm in diameter and a micropore volume of at least 0.17 cm³/g.

16. A process for preparing a large mesopore Y zeolite comprising:
a) providing a parent Y zeolite and heating the Y zeolite in a basic solution with a zinc salt and a CTA surfactant;
b) collecting solids from a) and washing and drying the solids;
c) calcining the washed solids from b);
d) subjecting calcined solids from c) to a hydrothermal treatment run at a temperature of about 135° C., and
e) calcining hydrothermal treated material from d).

17. The process of claim 16, wherein the CTA surfactant is a bromide (CTAB).

18. The process of claim 16, further comprising an acid wash of calcined hydrothermal treated material from step e).

19. A large mesopore Y zeolite comprising mesopores of at least 18 nm in diameter and a micropore volume of at least 0.16 cm³/g.

20. The large mesopore Y zeolite of claim 19, wherein the micropore volume is at least 0.17 cm³/g.
